(19) United States
(12) Patent Application Publication
(10) Pub. No.: US 2026/0087508 A1
(43) Pub. Date: Mar. 26, 2026

(54) AI-OPTIMIZED COMPLIANCE-ADAPTIVE EXECUTION ENGINE

(71) Applicant: George Bickerstaff Bickerstaff, III, Greenwich, CT (US)

(72) Inventor: George Bickerstaff Bickerstaff, III, Greenwich, CT (US)

(21) Appl. No.: 19/407,399

(22) Filed: Dec. 3, 2025

(51) Int. Cl. G06Q 30/018

(52) U.S. Cl. CPC G06Q 30/018

(57) ABSTRACT

An AI-optimized compliance-adaptive execution engine aggregates data from secure APIs, generates regulatory constraint models using transformer-based NLP and generative AI, forecasts regulatory changes, harmonizes cross-jurisdictional rules via graph optimization, predicts client-specific violation risks using reinforcement learning, and executes or rewrites actions to ensure regulatory compliance. All actions are logged to a cryptographically-secured ledger, and analytics are delivered through secure interfaces. The system improves accuracy, reduces false positives, and enhances auditability.

### CROSS-REFERENCE TO RELATED APPLICATIONS

None.

### STATEMENT REGARDING FEDERALLY SPONSORED RESEARCH OR DEVELOPMENT

Not applicable.

### INCORPORATION BY REFERENCE

None.

### BACKGROUND OF THE INVENTION

### Field of the Invention

The invention relates to computer-implemented financial compliance systems. Specifically, it concerns an AI-optimized execution engine that dynamically interprets, forecasts, reconciles, and applies regulatory constraints in real-time, rewrites non-compliant actions, and produces cryptographically auditable operational logs.

### Technical Field

The invention improves the functioning of compliance automation engines by using:
transformer-based semantic understanding of regulations
generative AI for rule synthesis
time-series forecasting for regulatory change
graph-based multi-jurisdictional constraint harmonization
reinforcement-learning violation prediction
blockchain-secured audit trails
vector-database semantic retrieval

This combination provides technical advantages over existing rule-based or deterministic compliance systems that cannot adapt to regulatory shifts or client-specific behavior.

### DESCRIPTION OF RELATED ART

Financial institutions increasingly automate trade execution, client communications, and compliance monitoring. However, existing technologies exhibit several technical limitations:
1. Static Regulatory Rule Engines
   Prior systems rely on manually curated rule sets that cannot adjust to evolving regulations (e.g., SEC, FINRA, FCA, MiFID II).
   Limitation: No predictive updating, leading to compliance drift.
2. Lack of Multi-Jurisdiction Harmonization
   Existing platforms cannot reconcile conflicts among heterogeneous regulatory bodies.
   Limitation: Inconsistent constraint outcomes, high false positives.
3. Client-Generic Compliance Behavior Modeling
   Prior systems fail to adapt compliance interpretation based on client behaviors, preferences, or risk patterns.
   Limitation: No personalization or predictive risk scoring.
4. Limited Auditability and Transparency
   Logging mechanisms do not cryptographically guarantee integrity.
   Limitation: Weak audit trail and regulator trust.

### DISTINCTION OVER PRIOR ART

U.S. Pat. No. 8,751,402 teaches static rule processing but not predictive constraint generation.
U.S. Pub. No. 2019/0156237 discloses compliance routing but lacks graph-based cross-jurisdictional harmonization.
U.S. Pub. No. 2020/0160481 describes automated compliance checks but not RL-based violation forecasting or real-time rewriting.

None of the prior references combine AI-driven regulatory forecasting, constraint graph harmonization, RL-based violation modeling, and blockchain logging into a unified execution engine.

This integration produces a non-obvious technical synergy, not predictable from prior art.

### SUMMARY OF THE INVENTION

The invention provides a computer-implemented system, method, and computer-readable medium for compliance-adaptive execution in wealth management and financial operations.

### System Components (High-Level)

1. Multi-Stream Data Integrator
   Aggregates client, market, behavioral, and regulatory data via secure APIs; stores them in vector databases for semantic retrieval.
2. Adaptive Constraint Forecaster
   Uses transformer NLP and generative AI to synthesize regulatory constraint models. Automatically updates models with time-series regulatory forecasting.
3. Jurisdictional Harmonizer
   Employs graph-based optimization to merge and reconcile constraints from multiple jurisdictions into a conflict-free unified regulatory rule set.
4. Client-Tailored Violation Predictor
   Computes violation probabilities using reinforcement learning trained on historical actions, communications sentiment, and market context.
5. Compliance-adaptive Execution Engine
   Executes compliant actions, rewrites non-compliant actions, and logs every decision in a blockchain-backed audit layer.
   Provides analytics via secure APIs to dashboards and mobile devices.

### Technical Improvement

The invention improves computer functionality by:
reducing false-positive compliance alerts
increasing accuracy of constraint interpretation
dynamically forecasting rule changes
providing adaptive rewriting of non-compliant actions
maintaining tamper-proof audit logs

This constitutes a tangible improvement in computational compliance systems.

### BRIEF DESCRIPTION OF THE DRAWINGS

(All figures harmonize with the drawing labels in the PowerPoint. All titles are ≤5 words.)

FIG. 1—SYSTEM ARCHITECTURE OVERVIEW

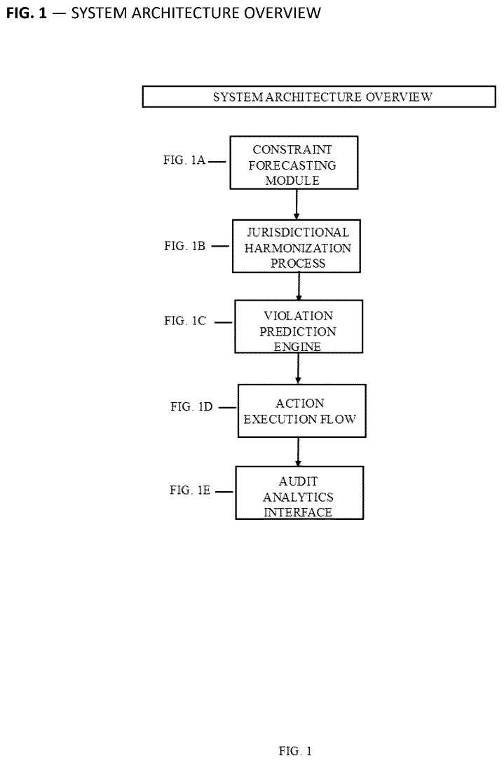

1A—Constraint Forecasting Module

1B—Jurisdictional Harmonization

1C—Violation Prediction Engine

1D—Execution Flow

1E—Audit Analytics Interface

FIG. 2—CONSTRAINT FORECASTING PROCESS

2A—Regulatory Text Extraction

2B—NLP Model Processing

2C—Constraint Model Generation

2D—Time-Series Forecasting

2E—Database Storage Flow

FIG. 3—JURISDICTIONAL HARMONIZATION FLOW

3A—Constraint Graph Mapping

3B—Prioritization Logic

3C—Conflict Resolution

3D—Harmonized Output Display

3E—Real-Time Update Mechanism

FIG. 4—VIOLATION PREDICTION SYSTEM

4A—Action Input Processing

4B—Reinforcement Learning Model

4C—Risk Probability Output

4D—Market Data Integration

4E—Calibration Flow

FIG. 5—AUDIT ANALYTICS INTERFACE

5A—Blockchain Logging

5B—Analytics API Delivery

5C—Dashboard Visualization

5D—Client Value Weighting

5E—Secure Data Flow

### DETAILED DESCRIPTION OF THE INVENTION

### 1. Multi-Stream Data Integrator

This module ingests and unifies:
client profile data, prior decisions, communication transcripts
market feeds (prices, volatility, liquidity)
regulatory texts from SEC, FINRA, FCA, ESMA, ASIC, MAS, MiFID II
historical compliance outcomes

### Advisor Metadata

Data is processed via secure APIs (REST, gRPC) and ingested into a vector database, enabling high-dimensional retrieval aligned with semantic relevance.

### Alternative Embodiments

Data integration may use SQL, NoSQL, or hybrid storage.
Vector DB may be Pinecone, FAISS, Vespa, PostgreSQL-pgvector.

### 2. Adaptive Constraint Forecaster

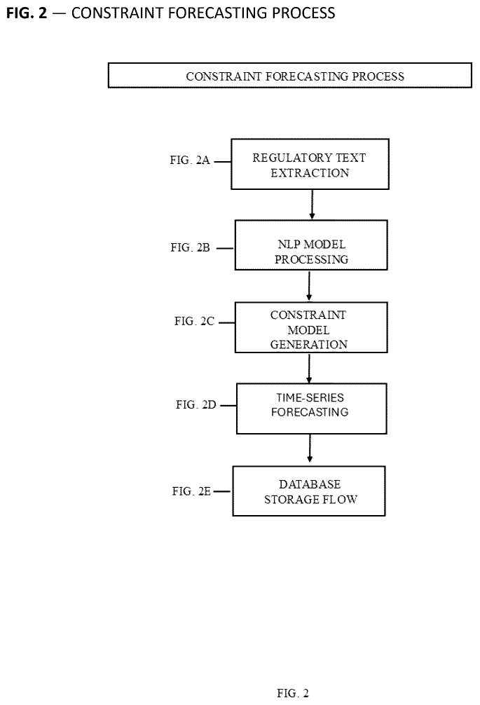

Steps include:
1. ingestion of regulatory documents (FIG. 2A);
2. transformer-based NLP analysis to detect regulatory obligations and prohibitions (FIG. 2B);
3. generative AI synthesis of constraint models (FIG. 2C);
4. time-series forecasting to predict rule changes (FIG. 2D);
5. storage of evolving constraint models (FIG. 2E).

### Technical Improvement

Transformer models reduce semantic misclassification, enabling higher accuracy than deterministic regex or keyword-rule systems.

### Alternative Embodiments

Models may use GPT derivatives, FinBERT, or LLaMA variants.
Forecasting may use ARIMA, Prophet, LSTM.

### 3. Jurisdictional Harmonizer

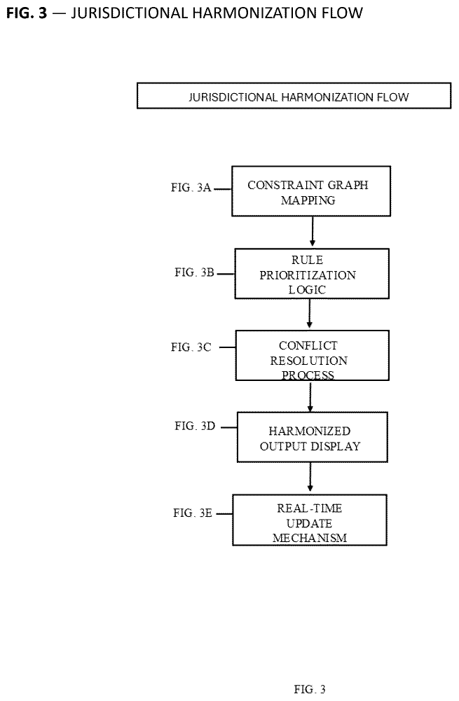

Steps include:
constructing a constraint graph (FIG. 3A),
applying rule priority logic (FIG. 3B),
resolving conflicting obligations (FIG. 3C),
producing harmonized rules (FIG. 3D),
updating harmonized outputs dynamically through real-time feeds (FIG. 3E).

### Alternative Embodiments

Graph algorithms may include Dijkstra, Bellman-Ford, or SAT-solver approaches.
Conflicts may be resolved via linear programming or constraint satisfaction.

### 4. Client-Tailored Violation Predictor Inputs:

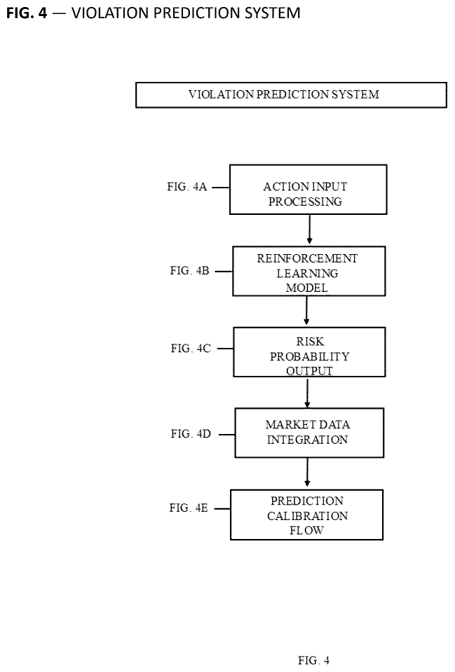

action metadata (trade size, timing, jurisdiction),
communication sentiment,
historical compliance outcomes,
behavioral norms,
real-time market factors (FIG. 4D).

A reinforcement-learning model (Q-learning, actor-critic, PPO, or DQN) outputs numerical violation probabilities (FIG. 4C).

Calibration loops (FIG. 4E) refine prediction accuracy using continuous feedback.

### Technical Improvement

Adaptive modeling reduces false positives and improves system efficiency.

### 5. Compliance-Adaptive Execution Engine

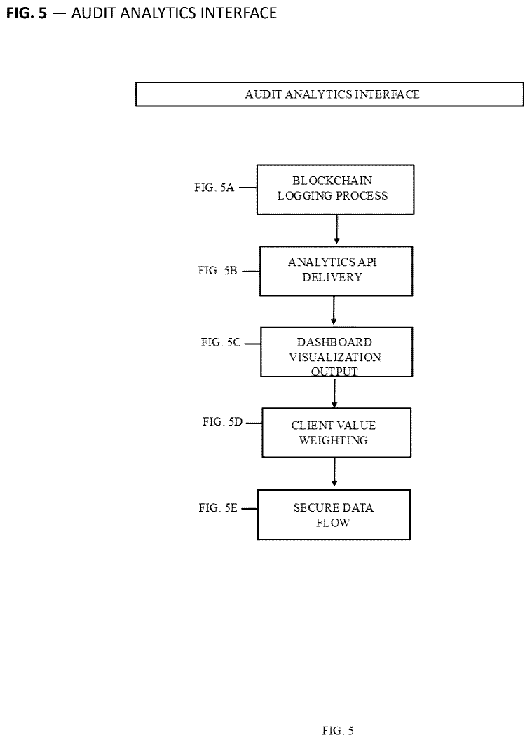

The engine:
executes compliant actions;
rewrites non-compliant instructions to satisfy harmonized constraints;
applies disclosure sequencing;
adjusts trade size or timing;
produces cryptographically-signed logs (FIG. 5A);
delivers analytics via secure APIs to dashboards and devices (FIG. 5B-5E).

### Alternative Embodiments

Blockchain may be Corda, Hyperledger, Ethereum, or any distributed ledger.
Execution rewriting may use rule-based, neural symbolic, or hybrid logic.

1. A computer-implemented method for compliance-adaptive execution in financial operations, comprising:
(a) aggregating client, market, behavioral, and regulatory data objects via secure application programming interfaces and storing the objects in a vector database;
(b) generating regulatory constraint models using transformer-based natural language processing and generative artificial intelligence, and updating the models using time-series forecasting;
(c) harmonizing regulatory constraints across multiple jurisdictions using graph-based optimization to produce a unified constraint set;
(d) computing client-specific compliance-violation probabilities using a reinforcement-learning model;
(e) executing compliant actions or rewriting non-compliant actions based on the unified constraint set and the violation probabilities; and
(f) logging the executed or rewritten actions in a cryptographically-secured, tamper-resistant audit ledger.

2. A system comprising one or more processors and a non-transitory memory storing instructions that, when executed, cause the processors to perform the method of claim 1, and further comprising an interface configured to deliver compliance analytics to dashboards or mobile devices.

3. A non-transitory computer-readable medium storing instructions that, when executed by one or more processors, cause performance of the method of claim 1.

4. The method of claim 1, wherein the natural language processing comprises a transformer-based domain-specialized financial language model.

5. The method of claim 1, wherein harmonizing regulatory constraints comprises constructing a constraint graph including override, dependency, and conflict edges.

6. The method of claim 1, wherein computing violation probabilities includes analyzing communication sentiment extracted from client interactions.

7. The method of claim 1, wherein the tamper-resistant ledger comprises any distributed ledger technology including Corda, Hyperledger, or Ethereum.

8. The method of claim 1, wherein rewriting non-compliant actions comprises modifying trade size, timing, disclosure sequencing, or communication text.

9. The system of claim 2, wherein the interface integrates with Salesforce, Bloomberg, Thomson Reuters, or Kafka platforms for analytics delivery.

10. The medium of claim 3, wherein compliance analytics include violation likelihoods, constraint lineage visualizations, and client-engagement metrics.
